(19) United States
(12) Patent Application Publication
(10) Pub. No.: US 2025/0105276 A1
(43) Pub. Date: Mar. 27, 2025

(54) POSITIVE ELECTRODE FOR SECONDARY BATTERIES AND SECONDARY BATTERY

(71) Applicant: Panasonic Energy Co., Ltd., Moriguchi-shi, Osaka (JP)

(72) Inventor: Tomohiro Harada, Osaka (JP)

(73) Assignee: Panasonic Energy Co., Ltd., Moriguchi-shi, Osaka (JP)

(21) Appl. No.: 18/832,221

(22) PCT Filed: Jan. 18, 2023
(86) PCT No.: PCT/JP2023/001407

§ 371 Date: Jul. 23, 2024

(30) Foreign Application Priority Data
Jan. 26, 2022 (JP) 2022-009966

(51) Int. Cl. H01M 4/525; H01M 4/02; H01M 4/131; H01M 4/62

(52) U.S. Cl. CPC H01M 4/525; H01M 4/131; H01M 4/624; H01M 2004/028

(57) ABSTRACT

This positive electrode for secondary batteries is characterized by comprising: a positive electrode current collector; and a positive electrode mixture layer that contains a positive electrode active material. The positive electrode for secondary batteries is characterized in that: when the positive electrode mixture layer is divided into two in the thickness direction, and the lower half on the positive electrode current collector side is denoted as a first region and the upper half on the surface side of the positive electrode current collector is denoted as a second region, the first region and the second region contain the same kind of electrical conductive material; and the D-band/G-band ratio (X) of the Raman spectrum obtained by the electrical conductive material in the first region is larger than the D-band/G-band ratio (Y) of the Raman spectrum obtained by the electrical conductive material in the second region.

### TECHNICAL FIELD

The present disclosure relates to a positive electrode for a secondary battery and a secondary battery.

### BACKGROUND

As a positive electrode for a secondary battery used in a secondary battery, for example, Patent Literatures 1 and 2 disclose a positive electrode for a secondary battery including a positive electrode current collector and a positive electrode mixture layer formed on the positive electrode current collector, in which the positive electrode mixture layer contains a positive electrode active material and a first conductive agent, the first conductive agent has a D-band/G-band ratio of a Raman spectrum obtained from the positive electrode mixture layer by Raman spectroscopy of greater than 0.6 and less than or equal to 10, and in a constituent material mapping image of the positive electrode mixture layer obtained by using Raman spectroscopy, a ratio of an area occupied by the first conductive agent to an area occupied by the positive electrode active material is greater than or equal to 1.5 and less than or equal to 5.

### CITATION LIST

### Patent Literature

PATENT LITERATURE 1: JP 2019-3946 A
PATENT LITERATURE 2: JP 2015-84323 A

### SUMMARY

An object of the present disclosure is to provide a positive electrode for a secondary battery and a secondary battery capable of suppressing an increase in direct current resistance (DCR) when charging and discharging of the battery are repeated.

According to one aspect of the present disclosure, a positive electrode for a secondary battery includes a positive electrode current collector and a positive electrode mixture layer that is provided on the positive electrode current collector and contains a positive electrode active material, in which in a case where the positive electrode mixture layer is divided into two in a thickness direction, a lower half on a side of the positive electrode current collector is defined as a first region, and an upper half on a surface side of the positive electrode mixture layer is defined as a second region, the first region and the second region contain the same kind of conductive agent, and a D-band/G-band ratio (X) of a Raman spectrum obtained from the conductive agent in the first region is greater than a D-band/G-band ratio (Y) of a Raman spectrum obtained from the conductive agent in the second region.

In addition, according to one aspect of the present disclosure, a secondary battery includes the positive electrode for a secondary battery.

According to one aspect of the present disclosure, it is possible to provide a positive electrode for a secondary battery and a secondary battery capable of suppressing an increase in direct current resistance (DCR) when charging and discharging of the battery are repeated.

### BRIEF DESCRIPTION OF DRAWINGS

FIG. 1 is a schematic cross-sectional view of a secondary battery as an example of an embodiment.

FIG. 2 is a schematic cross-sectional view of a positive electrode as an example of an embodiment.

### DESCRIPTION OF EMBODIMENTS

Hereinafter, an example of a secondary battery according to one aspect of the present disclosure will be described.

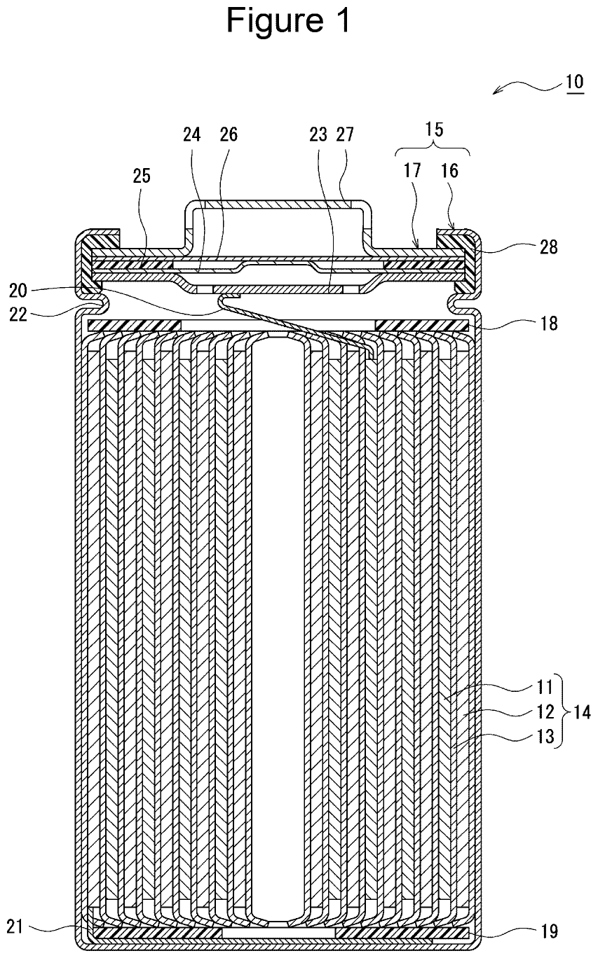

FIG. 1 is a schematic cross-sectional view of a secondary battery as an example of an embodiment. A secondary battery 10 illustrated in FIG. 1 includes a wound electrode assembly 14 formed by wounding a positive electrode 11 and a negative electrode 12 with a separator 13 interposed between the positive electrode and the negative electrode, an electrolyte, insulating plates 18 and 19 that are disposed on upper and lower sides of the electrode assembly 14, respectively, and a battery case 15 housing the members. The battery case 15 includes a bottomed cylindrical case body 16 and a sealing assembly 17 for closing an opening of the case body 16. Note that, instead of the wound electrode assembly 14, an electrode assembly having another form, such as a stacked electrode assembly in which positive electrodes and negative electrodes are alternately stacked with separators interposed therebetween, may be applied. Examples of the battery case 15 include metal cases having a cylindrical shape, a square shape, a coin shape, a button shape, or the like, and resin cases (so-called laminated type) formed by lamination with a resin sheet.

The electrolyte may be an aqueous electrolyte, and is preferably a non-aqueous electrolyte containing a non-aqueous solvent and an electrolyte salt dissolved in the non-aqueous solvent. As the non-aqueous solvent, for example, esters, ethers, nitriles, amides, a mixed solvent of two or more thereof, and the like are used. The non-aqueous solvent may contain a halogen-substituted product in which at least some hydrogen in a solvent described above is substituted with a halogen atom such as fluorine. Examples of the electrolyte salt include lithium salts such as LiPF₆. Note that the electrolyte is not limited to a liquid electrolyte, and may be a solid electrolyte in which a gel polymer or the like is used.

The case body 16 is, for example, a bottomed cylindrical metal container. A gasket 28 is provided between the case body 16 and the sealing assembly 17 to ensure the sealability inside the battery. The case body 16 has a projecting portion 22 in which, for example, a part of the side part of the case body 16 protrudes inward to support the sealing assembly 17. The projecting portion 22 is preferably formed in an annular shape along a circumferential direction of the case body 16, and supports the sealing assembly 17 on an upper surface thereof.

The sealing assembly 17 has a structure in which a filter 23, a lower vent member 24, an insulating member 25, an upper vent member 26, and a cap 27 are sequentially stacked from the electrode assembly 14. Each member included in the sealing assembly 17 has, for example, a disk shape or a ring shape, and the members excluding the insulating member 25 are electrically connected to each other. The lower vent member 24 and the upper vent member 26 are connected to each other at their central parts, and the insulating member 25 is interposed between the circumferential parts of the lower vent member 24 and the upper vent member 26. When the internal pressure of the secondary battery 10 increases due to heat generated by an internal short circuit or the like, for example, the lower vent member 24 deforms so as to push the upper vent member 26 up toward the cap 27 side and breaks, and thus the current pathway between the lower vent member 24 and the upper vent member 26 is cut off. When the internal pressure is further increased, the upper vent member 26 is broken, and gas is discharged through the opening of the cap 27.

In the secondary battery 10 illustrated in FIG. 1, a positive electrode lead 20 attached to the positive electrode 11 extends to the sealing assembly 17 side through a through hole of the insulating plate 18, and a negative electrode lead 21 attached to the negative electrode 12 extends to the bottom side of the case body 16 through the outside of the insulating plate 19. The positive electrode lead 20 is connected to the lower surface of the filter 23, which is the bottom plate of the sealing assembly 17, by welding or the like, and the cap 27, which is electrically connected to the filter 23 and is the top plate of the sealing assembly 17, serves as a positive electrode terminal. The negative electrode lead 21 is connected to a bottom inner surface of the case body 16 by welding or the like, and the case body 16 becomes a negative electrode terminal.

Hereinafter, the positive electrode 11, the negative electrode 12, and the separator 13 will be described in detail.

### [Positive Electrode]

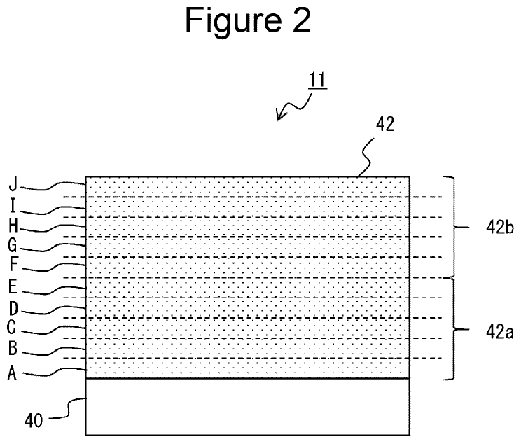

FIG. 2 is a schematic cross-sectional view of a positive electrode as an example of an embodiment. The positive electrode 11 includes a positive electrode current collector 40 and a positive electrode mixture layer 42 provided on the positive electrode current collector. As the positive electrode current collector 40, a foil of a metal stable in a potential range of the positive electrode 11, such as aluminum, a film in which the metal is disposed on a surface layer, or the like can be used. The positive electrode mixture layer 42 contains a positive electrode active material and a conductive agent. The positive electrode mixture layer 42 preferably further contains a binder and the like.

The positive electrode 11 can be manufactured, for example, by applying a positive electrode mixture slurry containing a positive electrode active material, a binder, a conductive agent, and the like onto the positive electrode current collector 40 and drying the positive electrode mixture slurry to form a positive electrode mixture layer 42, and then rolling the positive electrode mixture layer 42 by a rolling roller or the like. Note that a method for manufacturing the positive electrode mixture layer 42 will be described in detail.

The positive electrode mixture layer 42 illustrated in FIG. 2 is divided into two in a thickness direction, and a lower half on a side of the positive electrode current collector 40 is defined as a first region 42a, and an upper half on a surface side of the positive electrode mixture layer 42 is defined as a second region 42b. The conductive agents included in the first region 42a and the second region 42b are the same kind of conductive agent. The conductive agent of the present embodiment is a carbon-based conductive agent such as amorphous carbon (for example, carbon black, acetylene black, Ketjenblack, or the like), graphite, carbon nanotubes, or the like.

In the present embodiment, a D-band/G-band ratio (X) of a Raman spectrum obtained from the conductive agent in the first region 42a by Raman spectroscopy is greater than a D-band/G-band ratio (Y) of a Raman spectrum obtained from the conductive agent in the second region 42b by Raman spectroscopy. Note that the “D-band” indicates a Raman band around 1,360 cm⁻¹ derived from a defect or an amorphous carbon component. In addition, the “G-band” indicates a Raman band around 1,580 cm⁻¹ derived from a C═C bond. As described above, the relationship of X>Y is satisfied, such that it is possible to suppress an increase in direct current resistance due to repetition of charging and discharging of the battery. Although the mechanism of exerting the effect is not sufficiently clear, the following is presumed.

It is considered that the D-band/G-band ratio of the Raman spectrum of the conductive agent depends on a distribution state of the conductive agent in the region. Specifically, the more the conductive agent in the aggregated state is present in the region, the more the intensity of the D-band increases or the intensity of the G-band decreases in the Raman spectrum obtained from the conductive agent in the region, and the D-band/G-band ratio increases. Therefore, since the conductive agent in the first region 42a is present in a more aggregated state than the conductive agent in the second region 42b, it is presumed that a conductive path in the first region 42a is less likely to be cut even when the positive electrode mixture layer 42 expands and contracts due to repetition of charging and discharging of the battery. As a result, it is considered that the conductive path between the positive electrode current collector 40 and the positive electrode mixture layer 42 is also hardly cut, such that the increase in direct current resistance is suppressed.

A ratio (Y/X) of the D-band/G-band ratio (Y) of the Raman spectrum obtained from the conductive agent in the second region 42b to the D-band/G-band ratio (X) of the Raman spectrum obtained from the conductive agent in the first region 42a is preferably in a range of greater than or equal to 0.85 and less than or equal to 0.98 from the viewpoint of further suppressing an increase in direct current resistance due to repetition of charging and discharging of the battery. With the ratio Y/X as described above, even when the positive electrode mixture layer expands and contracts, the conductive path in the first region 42a is more hardly cut, and it is possible to further suppress an increase in direct current resistance due to repetition of charging and discharging of the battery. In addition, since the conductive agent in the second region 42b is present in a relatively uniformly dispersed state, an electrolytic solution easily infiltrates from the surface of the positive electrode mixture layer 42, and it is possible to further suppress an increase in direct current resistance due to repetition of charging and discharging of the battery.

Hereinafter, a measurement method of Raman spectroscopy will be described.

First, the positive electrode 11 is embedded in a resin, and a cross section of the positive electrode mixture layer is produced by cross section polisher (CP) processing or the like. Then, the Raman spectroscopic mapping is performed on the cross section of the positive electrode mixture layer in a field of view in which the entire range falls within a plate width of 100 μm×a thickness direction of the plate to obtain mapping data of a Raman chart. When the Raman chart is obtained, measurement is performed at points obtained by dividing the field of view in the above range at intervals of 1 μm in length and 1 μm in width. Next, significant spectral components are separated from the Raman chart for each of the above points. For each of the separated component spectra, the positive electrode active material, the conductive agent, and the like are discriminated from the peak position, the intensity, and the intensity ratio. The conductive agent has sharp peaks around 1,360 cm⁻¹ (D-band) and around 1,580 cm⁻¹ (G-band) in the Raman chart. Among the data of each point, an average value of the respective intensities of the D-band and the G-band of only the data of points where the position where the conductive agent having a sharp peak is present in the D-band and the G-band was measured was taken as a spectral intensity of the D-band and the G-band in the area.

### <Measurement Conditions of Raman Spectroscopy>

Laser light source: Nd—YVO4
Laser wavelength: 532 nm (visible light)
Number of integration times: 1
Exposure time: 10 seconds
Lens: 50 times
Measurement range: entire range in 100 μm in plate width direction×plate thickness direction
Standard material: Si crystal (having a peak at greater than or equal to 519.5 cm⁻¹ and less than or equal to 521.5 cm⁻¹)

Examples of the positive electrode active material contained in the positive electrode mixture layer 42 include lithium composite oxides containing transition metal elements such as Co, Mn, and Ni. The lithium composite oxide may contain, for example, Ni, Co, Mu, Al, Zr, B, Mg, Sc, Y, Ti, Fe, Cu, Zu, Cr, Pb, Sn, Na, K, Ba, Sr, Ca, W, Mo, Nb, Si, or the like. These lithium composite oxides may be used alone or as a mixture of a plurality of kinds.

In addition, from the viewpoint that a high capacity of the secondary battery can be achieved, it is preferable that the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr), and in the formula, it is more preferable that y=0. Note that, the lithium composite oxide represented by the general formula described above is used, and therefore, in general, direct current resistance due to repetition of charging and discharging of the battery is likely to increase. However, in the present embodiment, as described above, since the effect of suppressing the increase in direct current resistance due to repetition of charging and discharging of the battery is exhibited, even when the lithium composite oxide represented by the general formula described above is used, the increase in direct current resistance due to repetition of charging and discharging of the battery can be suppressed.

Examples of the binder contained in the positive electrode mixture layer 42 include fluororesins such as polytetrafluoroethylene (PTFE) and polyvinylidene fluoride (PVdF), polyacrylonitrile (PAN), polyimide, acrylic resins, styrene-butadiene rubber (SBR), polyolefins, cellulose derivatives such as carboxymethyl cellulose (CMC) and its salts, and polyethylene oxide (PEO).

The positive electrode mixture layer 42 illustrated in FIG. 2 is divided into ten in the thickness direction, and regions obtained by dividing the positive electrode mixture layer into ten are defined as an A region, a B region, a C region, a D region, an E region, an F region, a G region, an II region, an I region, and a J region in this order from the positive electrode current collector 40 side.

In the present embodiment, the ratio (W/V) of the highest content (W) among the contents of the binder included in each of the D region, the E region, and the F region to the highest content (V) among the contents of the binder included in each of the A region, the B region, and the C region is preferably less than 1.3. When the ratio W/V is less than 1.3, the content of the binder in the regions A to C close to the positive electrode current collector 40 becomes large as compared with the case where the ratio of W/V is greater than or equal to 1.3, such that the adhesive force between the positive electrode current collector 40 and the positive electrode mixture layer 42 becomes strong. As a result, even when the positive electrode mixture layer 42 expands and contracts due to repetition of charging and discharging of the battery, the positive electrode mixture layer 42 is suppressed from being peeled off from the positive electrode current collector 40, and thus it is considered that an increase in direct current resistance is further suppressed.

Here, the content of the binder included in each region means a ratio of the amount of the binder included in each region to the total amount of the binder included in the entire region (that is, the A region to the J region). Such a content is analyzed with an electron probe microanalyzer (EPMA) along the surface side of the positive electrode mixture layer 42 from the positive electrode current collector 40 side with respect to the cross section of the positive electrode mixture layer 42, and the content of elements constituting the binder is measured in each region. Then, the content of the binder is converted from the measured content of the elements. As the electron probe microanalyzer (EPMA), for example, EMPA-1600 (product name) manufactured by Shimadzu Corporation is used.

### <Measurement Conditions of EPMA>

Acceleration voltage: 15 kV
Beam diameter: 2 μm
Integration time: 1 second
Step interval: 2 μm
Sample current: 0.15 μA

An example of a method for manufacturing the positive electrode mixture layer 42 will be described. For example, a first positive electrode mixture slurry can be prepared by mixing a positive electrode active material, a binder, a conductive agent, and the like together with a solvent. In addition, separately the slurry, a second positive electrode mixture slurry can be prepared by mixing a positive electrode active material, a binder, a conductive agent, and the like together with a solvent. Then, the first positive electrode mixture slurry is applied onto the positive electrode current collector 40 at a predetermined thickness, and then the second positive electrode mixture slurry is applied onto the first positive electrode mixture slurry at a predetermined thickness and dried to form the positive electrode mixture layer 42. For example, a viscosity of the first positive electrode mixture slurry applied onto the positive electrode current collector 40 is set to be greater than a viscosity of the second positive electrode mixture slurry applied onto the first positive electrode mixture slurry, such that the D-band/G-band ratio (X) of the Raman spectrum obtained from the conductive agent in the first region 42a can be set to be greater than the D-band/G-ratio (Y) of the Raman spectrum obtained from the conductive agent in the second region 42b. The viscosity of the slurry may be adjusted by, for example, the solid content or the solvent amount of the slurry.

As another example of the method for producing the positive electrode mixture layer 42, the first positive electrode mixture slurry may be applied onto the positive electrode current collector 40 and dried, and then the second positive electrode mixture slurry may be applied onto the dried coating film at a predetermined thickness and dried. However, it is easier to adjust the W/V to less than 1.3 by simultaneous drying of a slurry in which the first positive electrode mixture slurry is applied onto the positive electrode current collector 40 at a predetermined thickness, the second positive electrode mixture slurry is applied onto the first positive electrode mixture slurry at a predetermined thickness, and the slurry is dried rather than such sequential drying of the slurry.

A content of the positive electrode active material contained in the positive electrode mixture layer 42 is preferably, for example, greater than or equal to 90 mass % with respect to the total mass of the positive electrode mixture layer 42. A content of the conductive agent contained in the positive electrode mixture layer 42 is preferably greater than or equal to 0.3 mass % with respect to the total mass of the positive electrode mixture layer 42. In addition, a content of the binder contained in the positive electrode mixture layer 42 is preferably greater than or equal to 0.3 mass % with respect to the total mass of the positive electrode mixture layer 42.

### [Negative Electrode]

The negative electrode 12 includes a negative electrode current collector and a negative electrode mixture layer provided on the negative electrode current collector. Examples of the negative electrode current collector include a foil of a metal stable in a potential range of the negative electrode, such as copper, and a film in which the metal is disposed on a surface layer.

It is preferable that the negative electrode mixture layer contains a negative electrode active material and further contains a binder or a conductive agent. The negative electrode 12 can be manufactured by preparing a negative electrode mixture slurry containing a negative electrode active material, a binder, and the like, applying the negative electrode mixture slurry onto the negative electrode current collector, performing drying to form the negative electrode mixture layer, and rolling the negative electrode mixture layer.

The negative electrode active material is not particularly limited as long as it is a material capable of occluding and releasing lithium ions, and examples thereof include metal lithium, lithium alloys such as a lithium-aluminum alloy, a lithium-lead alloy, a lithium-silicon alloy, and a lithium-tin alloy, carbon materials such as graphite, coke, and organic substance fired bodies, and metal oxides such as SnO₂, SnO, and TiO₂. These materials may be used alone or in combination of two or more thereof.

Examples of the binder and the conductive agent include materials similar to those for the positive electrode 11.

### [Separator]

As the separator 13, for example, a porous sheet having an ion permeation property and an insulation property is used. Specific examples of the porous sheet include fine porous thin films, woven fabrics, and nonwoven fabrics. As a material of the separator, olefin-based resins such as polyethylene and polypropylene, cellulose, and the like are suitable. The separator 13 may be a stacked body having a cellulose fiber layer and a thermoplastic resin fiber layer such as an olefin-based resin. The separator may be a multilayer separator including a polyethylene layer and a polypropylene layer, and a separator may be used that has a surface to which a material such as an aramid-based resin or a ceramic is applied.

### EXAMPLES

Hereinafter, the present disclosure will be further described with reference to Examples. However, the present disclosure is not limited to these Examples.

### Example 1

A lithium composite oxide represented by LiNi_{0.80}CO_{0.15}Al_{0.05}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 2 parts by mass of the dispersant polyvinylpyrrolindone. Next, N-methyl-2-pyrrolidone was added so that the solid content was 74.2%, and then the mixture was kneaded to prepare a positive electrode mixture slurry A having a solid content of 74.2% and a dispersant amount of 0.2%.

A lithium composite oxide represented by LiNi_{0.80}Co_{0.15}Al_{0.05}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 2 parts by mass of the dispersant polyvinylpyrrolindone. Next, N-methyl-2-pyrrolidone was added so that the solid content was 73.5%, and then the mixture was kneaded to prepare a positive electrode mixture slurry B having a solid content of 73.5% and a dispersant amount of 0.2%.

The positive electrode mixture slurry B was applied onto both surfaces of an aluminum foil having a thickness of 15 μm, the positive electrode mixture slurry A was applied onto the positive electrode mixture slurry B, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry A to the positive electrode mixture slurry B was set to 50:50.

In a case where the positive electrode mixture layer was divided into two in the thickness direction, the lower half on the side of the positive electrode current collector was defined as a first region, and the upper half on the surface side of the positive electrode mixture layer was defined as a second region, a ratio (Y/X) of the D-band/G-band ratio (Y) of the Raman spectrum in the conductive agent in the second region to the D-band/G-band ratio (X) of the Raman spectrum in the conductive agent in the first region was 0.96. The Raman spectrometry method is as described above.

In addition, in a case where the positive electrode mixture layer was divided into ten in the thickness direction, and regions obtained by dividing the positive electrode mixture layer into ten were defined as an A region, a B region, a C region, a D region, an E region, an F region, a G region, an H region, an I region, and a J region in this order from the positive electrode current collector, a ratio (W/V) of the highest content (W) among contents of the binders included in the respective regions of the D region, the E region, and the F region to the highest content (V) among contents of the binders included in the respective regions of the A region, the B region, and the C region was 1.05. The method for measuring the content of the binder in each region is as described above.

Hereinafter, a ratio Y/X and a ratio W/V will be simply described.

### [Manufacture of Negative Electrode]

Graphite, CMC, and SBR were mixed at a mass ratio of 98:1:1, and the mixture was kneaded with water, thereby preparing a negative electrode mixture slurry. The negative electrode mixture slurry was applied onto both surfaces of a copper foil having a thickness of 8 μm, the coating film was dried, and then the dried coating film was rolled by a rolling roller, thereby manufacturing a negative electrode in which a negative electrode mixture layer was formed on both surfaces of a negative electrode current collector.

### [Preparation of Non-Aqueous Electrolyte]

LiPF₆ was dissolved in a mixed solvent composed of ethylene carbonate (EC) and methylethyl carbonate (MEC) (EC:MEC=1:3 by volume ratio) at a concentration of 1 mol/L. The resulting mixture was used as a non-aqueous electrolyte.

### [Manufacture of Secondary Battery]

(1) A separator (a composite film of polyethylene and polypropylene) was wound between the positive electrode and the negative electrode to manufacture a wound electrode assembly. A lead was attached to each of the positive electrode and the negative electrode.
(2) The electrode assembly was inserted into a case body, the lead of the negative electrode was welded to the bottom of the case body, and the lead of the positive electrode was welded to a sealing assembly.
(3) A non-aqueous electrolyte was injected into the case body, and then an end part of an opening of the case body was caulked with the sealing assembly via a gasket. The battery was used as a secondary battery of Example 1.

### Example 2

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 2 parts by mass of the dispersant polyvinylpyrrolindone. Next, N-methyl-2-pyrrolidone was added so that the solid content was 74.2%, and then the mixture was kneaded to prepare a positive electrode mixture slurry C having a solid content of 74.2% and a dispersant amount of 0.2%.

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 1 part by mass of the dispersant polyvinylpyrrolindone. Next, N-methyl-2-pyrrolidone was added so that the solid content was 75.0%, and then the mixture was kneaded to prepare a positive electrode mixture slurry D having a solid content of 75.0% and a dispersant amount of 0.1%.

The positive electrode mixture slurry D was applied onto both surfaces of an aluminum foil having a thickness of 15 μm, the positive electrode mixture slurry C was applied onto the positive electrode mixture slurry D, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry D was set to 50:50.

In the manufactured positive electrode, the ratio Y/X was 0.88, and the ratio W/V was 1.03. A secondary battery was manufactured in the same manner as that of Example 1, except that the positive electrode was used.

### Example 3

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 1.5 parts by mass of the dispersant polyvinylpyrrolindone. Next, N-methyl-2-pyrrolidone was added so that the solid content was 75.0%, and then the mixture was kneaded to prepare a positive electrode mixture slurry E having a solid content of 75.0% and a dispersant amount of 0.15%.

The positive electrode mixture slurry E was applied onto both surfaces of an aluminum foil having a thickness of 15 μm, the positive electrode mixture slurry C was applied onto the positive electrode mixture slurry E, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry E was set to 50:50.

In the manufactured positive electrode, the ratio Y/X was 0.99, and the ratio W/V was 1.1. A secondary battery was manufactured in the same manner as that of Example 1, except that the positive electrode was used.

### Example 4

The positive electrode mixture slurry E was applied onto both surfaces of an aluminum foil having a thickness of 15 μm, drying was performed, the positive electrode mixture slurry C was applied onto a coating film of the obtained positive electrode mixture slurry E, and then drying was performed, thereby forming a coating film of the positive electrode mixture slurry C. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry E was set to 50:50.

In the manufactured positive electrode, the ratio Y/X was 0.99, and the ratio W/V was 1.47. A secondary battery was manufactured in the same manner as that of Example 1, except that the positive electrode was used.

### Comparative Example 1

A lithium composite oxide represented by LiNi_{0.80}Co_{0.15}Al_{0.05}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 3 parts by mass of the dispersant polyvinylpyrrolindone. Next, N-methyl-2-pyrrolidone was added so that the solid content was 75.0%, and then the mixture was kneaded to prepare a positive electrode mixture slurry F having a solid content of 75.0% and a dispersant amount of 0.3%.

The positive electrode mixture slurry F was applied onto both surfaces of an aluminum foil having a thickness of 15 μm, the positive electrode mixture slurry A was applied onto the positive electrode mixture slurry F, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry A to the positive electrode mixture slurry F was set to 50:50.

In the manufactured positive electrode, the ratio Y/X was 1.07, and the ratio W/V was 1.1. A secondary battery was manufactured in the same manner as that of Example 1, except that the positive electrode was used.

### Comparative Example 2

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 1.8 parts by mass of the dispersant polyvinylpyrrolindone. Next, N-methyl-2-pyrrolidone was added so that the solid content was 75.0%, and then the mixture was kneaded to prepare a positive electrode mixture slurry G having a solid content of 75.0% and a dispersant amount of 0.18%.

The positive electrode mixture slurry G was applied onto both surfaces of an aluminum foil having a thickness of 15 μm, the positive electrode mixture slurry C was applied onto the positive electrode mixture slurry G, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry G was set to 50:50.

In the manufactured positive electrode, the ratio Y/X was 1.04, and the ratio W/V was 1.11. A secondary battery was manufactured in the same manner as that of Example 1, except that the positive electrode was used.

### Comparative Example 3

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 2 parts by mass of the dispersant polyvinylpyrrolindone. Next, N-methyl-2-pyrrolidone was added so that the solid content was 73.5%, and then the mixture was kneaded to prepare a positive electrode mixture slurry H having a solid content of 73.5% and a dispersant amount of 0.2%.

The positive electrode mixture slurry H was applied onto both surfaces of an aluminum foil having a thickness of 15 μm, the positive electrode mixture slurry C was applied onto the positive electrode mixture slurry H, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry H was set to 50:50.

In the manufactured positive electrode, the ratio Y/X was 1.08, and the ratio W/V was 1.03. A secondary battery was manufactured in the same manner as that of Example 1, except that the positive electrode was used.

### Comparative Example 4

A lithium composite oxide represented by LiNi_{0.85}Al_{0.15}O₂, a conductive agent paste, and polyvinylidene fluoride were mixed at a solid content mass ratio of 100:10:1 to obtain a mixture. The conductive agent paste was prepared by mixing 10 parts by mass of Ketjenblack, 90 parts by mass of N-methyl-2-pyrrolidone, and 1 part by mass of the dispersant polyvinylpyrrolindone. Next, N-methyl-2-pyrrolidone was added so that the solid content was 73.5%, and then the mixture was kneaded to prepare a positive electrode mixture slurry I having a solid content of 73.5% and a dispersant amount of 0.1%.

The positive electrode mixture slurry I was applied onto both surfaces of an aluminum foil having a thickness of 15 μm, the positive electrode mixture slurry C was applied onto the positive electrode mixture slurry I, and then drying was performed, thereby forming a coating film. Thereafter, the coating film was rolled by a rolling roller to manufacture a positive electrode in which a positive electrode mixture layer was formed on both surfaces of a positive electrode current collector. A coating thickness ratio of the positive electrode mixture slurry C to the positive electrode mixture slurry I was set to 50:50.

In the manufactured positive electrode, the ratio Y/X was 1.22, and the ratio W/V was 1.05. A secondary battery was manufactured in the same manner as that of Example 1, except that the positive electrode was used.

### [Measurement of Direct Current Resistance]

In an environment of 25° C., the secondary battery of each of Examples and each of Comparative Examples was charged to SOC 50% at a constant current of 0.5 C. The voltage at this time was defined as V0. Next, discharge was performed at a constant current of 0.5 C for 10 seconds. The voltage at this time was defined as V1. Then, direct current resistance (DCR) was obtained from the following equation. This is referred to as an initial direct current resistance.

DCR=(V0−V1)/0.5 It

Next, the secondary battery of each of Examples and each of Comparative Examples was subjected to constant voltage charge at a constant current of 0.5 C until the voltage reached 4.2 V, and then subjected to constant voltage charge until the current reached 0.05 C. Thereafter, the battery was subjected to constant current discharge at a constant current of 0.5 C until the battery voltage reached 2.5 V. The charge and discharge was defined as one cycle, and 100 cycles were performed. Then, in an environment of 25° C., the secondary battery of each of Examples and each of Comparative Examples was subjected to constant current discharge at a constant current of 0.5 C until the voltage reached 3.0 V, and then the direct current resistance was determined by the same method as described above. This is defined as the direct current resistance after the charge and discharge cycle.

The initial direct current resistance and the direct current resistance after the charge and discharge cycle were applied to the following equation to determine a direct current resistance increase rate.

Direct current resistance increase rate=(Direct current resistance after charge and discharge cycle/Initial direct current resistance)×100

In Table 1, the direct current resistance increase rates of the other Examples and Comparative Examples with respect to the standard (100%) of the resistance increase rate of Comparative Example 1 as relative values are shown.

TABLE 1

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| Positive electrode | NCA | CoFree | CoFree | CoFree | NCA | CoFree | CoFree | CoFree |
| active material | | | | | | | | |
| Upper positive | A | C | C | C | A | C | C | C |
| electrode mixture | | | | | | | | |
| slurry | | | | | | | | |
| Lower positive | B | D | E | E | F | G | H | I |
| electrode mixture | | | | | | | | |
| slurry | | | | | | | | |
| Ratio Y/X | 0.96 | 0.88 | 0.99 | 0.99 | 1.07 | 1.04 | 1.08 | 1.22 |
| Positive electrode | Simultaneous | Simultaneous | Simultaneous | Sequential | Simultaneous | Simultaneous | Simultaneous | Simultaneous |
| mixture layer | drying | drying | drying | drying | drying | drying | drying | drying |
| production method | | | | | | | | |
| Ratio W/V | 1.05 | 1.03 | 1.1 | 1.47 | 1.1 | 1.11 | 1.03 | 1.05 |
| Direct current | 99.0% | 94.6% | 95.5% | 96.4% | 100.0% | 100.6% | 100.0% | 102.2% |
| resistance increase | | | | | | | | |
| rate | | | | | | | | |

As shown in Table 1, all of Examples 1 to 4 had a lower direct current resistance increase rate than Comparative Examples 1 to 4. Therefore, in a case where the positive electrode mixture layer is divided into two in the thickness direction, the lower half on the side of the positive electrode current collector is defined as a first region, and the upper half on the surface side of the positive electrode mixture layer is defined as a second region, the first region and the second region contain the same kind of conductive agent, and a positive electrode in which a D-band/G-band ratio (X) of a Raman spectra obtained from the conductive agent in the first region is greater than a D-band/G-band ratio (Y) of a Raman spectra obtained from the conductive agent in the second region is used, such that it is possible to suppress an increase in direct current resistance when the battery is repeatedly charged and discharged. In addition, when comparing Examples 3 and 4 using the same positive electrode mixture slurry, Example 3 showed a lower direct current resistance increase rate than Example 4. Therefore, in a case where the positive electrode mixture layer is divided into ten in the thickness direction, and regions obtained by dividing the positive electrode mixture layer into ten are defined as an A region, a B region, a C region, a D region, an E region, an F region, a G region, an II region, an I region, and a J region in this order from the positive electrode current collector, a positive electrode in which a ratio (W/V) of the highest content (W) among contents of the binders included in the respective regions of the D region, the E region, and the F region to the highest content (V) among contents of the binders included in the respective regions of the A region, the B region, and the C region is lower than 1.47 is used, such that it is possible to suppress an increase in direct current resistance when the battery is repeatedly charged and discharged.

### REFERENCE SIGNS LIST

10 Secondary battery
11 Positive electrode
12 Negative electrode
13 Separator
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket
40 Positive electrode current collector
42 Positive electrode mixture layer
42a First region
42b Second region

1. A positive electrode for a secondary battery, comprising: a positive electrode current collector; and a positive electrode mixture layer that is provided on the positive electrode current collector and contains a positive electrode active material,
wherein in a case where the positive electrode mixture layer is divided into two in a thickness direction, a lower half on a side of the positive electrode current collector is defined as a first region, and an upper half on a surface side of the positive electrode mixture layer is defined as a second region,
the first region and the second region contain the same kind of conductive agent, and
a D-band/G-band ratio (X) of a Raman spectrum obtained from the conductive agent in the first region is greater than a D-band/G-band ratio (Y) of a Raman spectrum obtained from the conductive agent in the second region.

2. The positive electrode for a secondary battery according to claim 1, wherein a ratio (Y/X) of the D-band/G-band ratio (Y) of the Raman spectrum obtained from the conductive agent in the second region to the D-band/G-band ratio (X) of the Raman spectrum obtained from the conductive agent in the first region is in a range of greater than or equal to 0.85 and less than or equal to 0.98.

3. The positive electrode for a secondary battery according to claim 1, wherein the positive electrode active material contains a lithium composite oxide represented by General Formula: LiₐNiₓCo_{y}M_{1-x-y}O₂ (where a, x, and y satisfy 0.97≤a≤1.2, 0.8≤x≤1.0, and 0≤y≤0.2, respectively, and M includes at least one selected from the group consisting of Mn, Al, B, W, Sr, Mg, Mo, Nb, Ti, Si, and Zr).

4. The positive electrode for a secondary battery according to claim 3, wherein in the general formula, y=0.

5. The positive electrode for a secondary battery according to claim 1,
wherein the positive electrode mixture layer contains a binder, and
in a case where the positive electrode mixture layer is divided into ten in the thickness direction, and regions obtained by dividing the positive electrode mixture layer into ten are defined as an A region, a B region, a C region, a D region, an E region, an F region, a G region, an H region, an I region, and a J region in this order from the positive electrode current collector,
a ratio (W/V) of the highest content (W) among contents of the binders included in the respective regions of the D region, the E region, and the F region to the highest content (V) among contents of the binders included in the respective regions of the A region, the B region, and the C region is less than 1.3.

6. A secondary battery comprising the positive electrode for a secondary battery according to claim 1.
